(19) United States
(12) Patent Application Publication
(10) Pub. No.: US 2022/0236870 A1
(43) Pub. Date: Jul. 28, 2022

(54) METHOD AND SYSTEM FOR COMPRESSION IN BLOCK-BASED STORAGE SYSTEMS

(71) Applicant: EMC IP Holding Company LLC, Hopkinton, MA (US)

(72) Inventors: Uri Shabi, Tel Mond (IL); Amitai Alkalay, Kadima (IL)

(73) Assignee: EMC IP Holding Company LLC, Hopkinton, MA (US)

(21) Appl. No.: 17/158,615

(22) Filed: Jan. 26, 2021

(51) Int. Cl. G06F 3/06

(52) U.S. Cl. CPC G06F 3/064; G06F 3/0673; G06F 3/0608; G06F 3/0653

(57) ABSTRACT

In a method used for dictionary-based compression in a block-based storage system, a stored block of data that is similar to a received block of data is identified. A dictionary based on the stored block of data is determined. The received block of data is compressed based on the dictionary based on the stored block of data. The compressed, received block of data is stored with an association to the stored block of data.

### BACKGROUND

### Technical Field

This application relates to compression in block-based storage systems.

### Description of Related Art

Computer systems may include different resources used by one or more host processors. Resources and host processors in a computer system may be interconnected by one or more communication connections. These resources may include, for example, data storage devices. These data storage systems may be coupled to one or more servers or host processors and provide storage services to each host processor. Multiple data storage systems from one or more different vendors may be connected and may provide common data storage for one or more host processors in a computer system.

A host processor may perform a variety of data processing tasks and operations using the data storage system. For example, a host processor may perform basic system I/O operations in connection with data requests, such as data read and write operations.

Host processor systems may store and retrieve data using a storage device containing a plurality of host interface units, disk drives, and disk interface units. The host systems access the storage device through a plurality of channels provided therewith. Host systems provide data and access control information through the channels to the storage device and the storage device provides data to the host systems also through the channels. The host systems do not address the disk drives of the storage device directly, but rather, access what appears to the host systems as a plurality of logical disk units. The logical disk units may or may not correspond to the actual disk drives. Allowing multiple host systems to access the single storage device unit allows the host systems to share data in the device. In order to facilitate sharing of the data on the device, additional software on the data storage systems may also be used.

Such a data storage system typically includes processing circuitry and a set of drives (disk drives are also referred to herein as simply “disks” or “drives”). In general, the processing circuitry performs load and store operations on the set of drives on behalf of the host devices. In certain data storage systems, the drives of the data storage system are distributed among one or more separate drive enclosures (disk drive enclosures are also referred to herein as “disk arrays” or “storage arrays”) and processing circuitry serves as a front-end to the drive enclosures. The processing circuitry presents the drive enclosures to the host device as a single, logical storage location and allows the host device to access the drives such that the individual drives and drive enclosures are transparent to the host device.

Storage arrays are typically used to provide storage space for one or more computer file systems, databases, applications, and the like. For this and other reasons, it is common for storage arrays to be structured into logical partitions of storage space, called logical units (also referred to herein as LUs or LUNs). For example, at LUN creation time, storage system may allocate storage space of various storage devices to be presented as a logical volume for use by an external host device. This allows a storage array to appear as a collection of separate file systems, network drives, and/or volumes.

Some data storage systems employ software compression and decompression to improve storage efficiency. For example, software compression involves loading compression instructions into memory and executing the instructions on stored data using one or more processing cores. A result of such software compression is that compressed data requires less storage space than the original, uncompressed data. Conversely, software decompression involves loading decompression instructions into the memory and executing the instructions on the compressed data using one or more of the processing cores, to restore the compressed data to its original, uncompressed form.

Other data storage systems perform compression and decompression in hardware. For example, a data storage system may include specialized hardware for compressing and decompressing data. The specialized hardware may be provided on the storage processor itself, e.g., as a chip, chipset, or sub-assembly, or on a separate circuit board assembly. Unlike software compression, which operates by running executable software instructions on a computer, hardware compression employs one or more ASICs (Application Specific Integrated Circuits), FPGAs (Field Programmable Gate Arrays), RISC (Reduced Instruction Set Computing) processors, and/or other specialized devices in which operations may be hard-coded and performed at high speed.

### SUMMARY OF THE INVENTION

One aspect of the current technique is a method for dictionary-based compression in block-based storage systems. The method includes identifying, by a processor of the block-based storage system, a stored block of data that is similar to a received block of data. The method also includes determining a dictionary based on the stored block of data. The method further includes compressing the received block of data based on the dictionary based on the stored block of data. The method also includes storing the compressed, received block of data with an association to the stored block of data.

The method may determine a similarity hash value of the received block of data, and compare the similarity hash value of the received block of data to similarity hash values of stored blocks of data. The method may select a stored block of data whose similarity hash value falls within a threshold of the similarity hash value of the received block of data. The method may create a dictionary based on the stored block of data, or use the stored block of data as raw data for the dictionary.

Another aspect of the current technique is a system, with a processor, for dictionary-based compression in block-based storage systems. The processor is configured to identify a stored block of data that is similar to a received block of data; determine a dictionary based on the stored block of data; compress the received block of data based on the dictionary based on the stored block of data; and store the compressed, received block of data with an association to the stored block of data. The processor may be configured to perform any other processes in conformance with the aspect of the current technique described above.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 depicts an exemplary embodiment of a computer system that may utilize the techniques described herein;

FIG. 2 depicts an exemplary embodiment of a data storage system used in the computer system of FIG. 1;

FIG. 3 depicts a schematic diagram of data blocks as compressed and stored on a data storage device of the data storage system of FIG. 1, according to dictionary-based compression techniques described herein; and

FIGS. 4-6 are exemplary flow diagrams of methods for dictionary-based compression in a block-based storage system.

### DETAILED DESCRIPTION OF EMBODIMENT(S)

Described below is a technique for compression in a block-based storage system, which technique may be used to provide, among other things, identifying a stored block of data that is similar to a received block of data; determining a dictionary based on the stored block of data; compressing the received block of data based on the dictionary based on the stored block of data; and storing the compressed, received block of data with an association to the stored block of data.

Data compression is an efficiency feature that allows users to store information using less storage capacity than storage capacity used without compression. With data compression, users can significantly increase storage utilization. Compression may be characterized as the process of encoding source information using an encoding scheme into a compressed form having fewer bits than the original or source information. Many techniques for compression leverage redundancy within the data. For example, data may include multiple instances of the same sequence of bytes. Replacing each instance with the same, shorter representation reduces the overall amount of data stored.

One exemplary type of encoding scheme uses dictionaries. A file-based storage system may create a dictionary based on data in a designated portion of storage, such as a file, folder, page, drive, or volume. For example, the storage system may create a dictionary for a file by analyzing its data, identifying redundant byte sequences, and associating each unique byte sequence with a distinct symbol. To compress the file using the dictionary, each byte sequence in the file that also appears in the dictionary is replaced with its corresponding symbol. The storage system may store both the file and its dictionary in persistent memory. When the storage system receives a request to read the file, the storage system may identify the dictionary to decompress the file, and load the file along with its dictionary. The file may be decompressed by replacing each instance of a dictionary symbol with its corresponding byte sequence.

Because the file-based storage system uses different dictionaries for different portions of storage, numerous dictionaries must be created and stored. Given the level of redundancy often present in known portions of storage (e.g., files, pages), dictionary-based compression techniques often use at least a 32 KB window for identifying redundant byte sequences. Furthermore, these compression techniques may accommodate large dictionaries, such as those that are 100 KB or larger, because of the reductions in data attained.

However, conventional dictionary-based compression techniques are inapplicable to block-based file systems, and do not yield the advantages that they reap in file-based storage systems. Some block-based file systems operate upon small blocks (e.g., 4 KB, 8 KB), which limit the windows that compression algorithms can use for identifying redundant byte sequences. Consequently, the limited window size diminishes the effectiveness of conventional compression techniques.

Furthermore, in some situations, a block-based storage system may service random read requests for small amounts of data. In a file-based storage system, when data resides on different portions of storage (e.g., pages, drives), the dictionary for each portion must be loaded to process the requests. As explained above, any given dictionary may be large, and the file-based system may have numerous dictionaries. However, in a block-based storage system, repeatedly loading large dictionaries to service read requests of small amounts of data consumes significant computing resources and hinders performance, such as input/output operations per second (IOPS).

Instead of creating dictionaries for predetermined portions of storage, compression techniques described herein create dictionaries for blocks based on their similarity. A block-based file system generates and stores similarity hash values for data blocks. When the file system receives a block, the file system determines its similarity hash value and uses this hash value to find a similar, stored block. A dictionary is created using the stored block, and the received block is compressed based on the dictionary. The compressed, received block is stored with a reference to the similar, stored block. Thus, when the compressed, received block is subsequently read, the block can be decompressed based on the similar block.

Furthermore, the compression techniques described herein may be used in combination with non-dictionary-based compression. Received blocks may also be compressed based on conventional compression, and the results may be compared against the dictionary-compressed versions of the blocks. Since the superior result is stored, dictionaries may not be retained if they do not yield results that are advantageous over other compression techniques.

In at least some implementations in accordance with the compression techniques as described herein, the use of dictionary-based compression in block-based storage systems can provide one or more of the following advantages: improved input/output operations per second (IOPS) performance, particularly for random read requests of small amounts of data (e.g., on the order of 4 KB); support of numerous dictionaries without corresponding sacrifice in performance; support for dictionaries of arbitrary block content; and reduced persistent memory required to store the dictionaries.

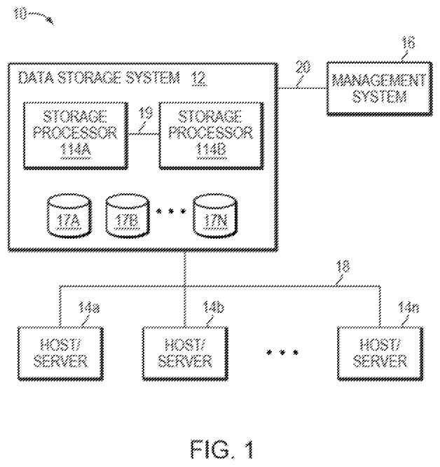

FIG. 1 depicts an example embodiment of a computer system 10 that may be used in connection with performing the techniques described herein. The system 10 includes one or more data storage systems 12 connected to server or hosts 14a-14n through communication medium 18. The system 10 also includes a management system 16 connected to one or more data storage systems 12 through communication medium 20. In this embodiment of the system 10, the management system 16, and the N servers or hosts 14a-14n may access the data storage systems 12, for example, in performing input/output (I/O) operations, data requests, and other operations. The communication medium 18 may be any one or more of a variety of networks or other type of communication connections as known to those skilled in the art. Each of the communication mediums 18 and 20 may be a network connection, bus, and/or other type of data link, such as a hardwire or other connections known in the art. For example, the communication medium 18 may be the Internet, an intranet, network or other wireless or other hardwired connection(s) by which the hosts 14a-14n may access and communicate with the data storage systems 12, and may also communicate with other components (not shown) that may be included in the system 10. In one embodiment, the communication medium 20 may be a LAN connection and the communication medium 18 may be an iSCSI, Fibre Channel, Serial Attached SCSI, or Fibre Channel over Ethernet connection.

Each of the hosts 14a-14n and the data storage systems 12 included in the system 10 may be connected to the communication medium 18 by any one of a variety of connections as may be provided and supported in accordance with the type of communication medium 18. Similarly, the management system 16 may be connected to the communication medium 20 by any one of variety of connections in accordance with the type of communication medium 20. The processors included in the hosts 14a-14n and management system 16 may be any one of a variety of proprietary or commercially available single or multi-processor system, or other type of commercially available processor able to support traffic in accordance with any embodiments described herein.

It should be noted that the particular examples of the hardware and software that may be included in the data storage systems 12 are described herein in more detail, and may vary with each particular embodiment. Each of the hosts 14a-14n, the management system 16 and data storage systems 12 may all be located at the same physical site, or, alternatively, may also be located in different physical locations. In connection with communication mediums 18 and 20, a variety of different communication protocols may be used such as SCSI, Fibre Channel, iSCSI, and the like. Some or all of the connections by which the hosts 14a-14n, management system 16, and data storage systems 12 may be connected to their respective communication medium 18, 20 may pass through other communication devices, such as switching equipment that may exist such as a phone line, a repeater, a multiplexer or even a satellite. In one embodiment, the hosts 14a-14n may communicate with the data storage systems 12 over an iSCSI or a Fibre Channel connection and the management system 16 may communicate with the data storage systems 12 over a separate network connection using TCP/IP. It should be noted that although FIG. 1 illustrates communications between the hosts 14a-14n and data storage systems 12 being over a first communication medium 18, and communications between the management system 16 and the data storage systems 12 being over a second different communication medium 20, other embodiments may use the same connection. The particular type and number of communication mediums and/or connections may vary in accordance with particulars of each embodiment.

Each of the hosts 14a-14n may perform different types of data operations in accordance with different types of tasks. In the embodiment of FIG. 1, any one of the hosts 14a-14n may issue a data request to the data storage systems 12 to perform a data operation. For example, an application executing on one of the hosts 14a-14n may perform a read or write operation resulting in one or more data requests to the data storage systems 12.

The management system 16 may be used in connection with management of the data storage systems 12. The management system 16 may include hardware and/or software components. The management system 16 may include one or more computer processors connected to one or more I/O devices such as, for example, a display or other output device, and an input device such as, for example, a keyboard, mouse, and the like. The management system 16 may, for example, display information about a current storage volume configuration, provision resources for a data storage system 12, and the like.

Each of the data storage systems 12 may include one or more data storage devices 17a-17n. Unless noted otherwise, data storage devices 17a-17n may be used interchangeably herein to refer to hard disk drive, solid state drives, and/or other known storage devices. One or more data storage devices 17a-17n may be manufactured by one or more different vendors. Each of the data storage systems included in 12 may be inter-connected (not shown). Additionally, the data storage systems 12 may also be connected to the hosts 14a-14n through any one or more communication connections that may vary with each particular embodiment. The type of communication connection used may vary with certain system parameters and requirements, such as those related to bandwidth and throughput required in accordance with a rate of I/O requests as may be issued by the hosts 14a-14n, for example, to the data storage systems 12. It should be noted that each of the data storage systems 12 may operate stand-alone, or may also be included as part of a storage area network (SAN) that includes, for example, other components such as other data storage systems 12. The particular data storage systems 12 and examples as described herein for purposes of illustration should not be construed as a limitation. Other types of commercially available data storage systems 12, as well as processors and hardware controlling access to these particular devices, may also be included in an embodiment.

In such an embodiment in which element 12 of FIG. 1 is implemented using one or more data storage systems 12, each of the data storage systems 12 may include code thereon for performing the techniques as described herein.

Servers or hosts, such as 14a-14n, provide data and access control information through channels on the communication medium 18 to the data storage systems 12, and the data storage systems 12 may also provide data to the host systems 14a-14n also through the channels 18. The hosts 14a-14n may not address the disk drives of the data storage systems 12 directly, but rather access to data may be provided to one or more hosts 14a-14n from what the hosts 14a-14n view as a plurality of logical devices or logical volumes (LVs). The LVs may or may not correspond to the actual disk drives. For example, one or more LVs may reside on a single physical disk drive. Data in a single data storage system 12 may be accessed by multiple hosts 14a-14n allowing the hosts 14a-14n to share the data residing therein. An LV or LUN (logical unit number) may be used to refer to the foregoing logically defined devices or volumes.

The data storage system 12 may be a single unitary data storage system, such as single data storage array, including two storage processors 114A, 114B or computer processing units. Techniques herein may be more generally use in connection with any one or more data storage system 12 each including a different number of storage processors 114 than as illustrated herein. The data storage system 12 may include a data storage array 116, including a plurality of data storage devices 17a-17n and two storage processors 114A, 114B. The storage processors 114A, 114B may include a central processing unit (CPU) and memory and ports (not shown) for communicating with one or more hosts 14a-14n. The storage processors 114A, 114B may be communicatively coupled via a communication medium such as storage processor bus 19. The storage processors 114A, 114B may be included in the data storage system 12 for processing requests and commands. In connection with performing techniques herein, an embodiment of the data storage system 12 may include multiple storage processors 114 including more than two storage processors as described. Additionally, the two storage processors 114A, 114B may be used in connection with failover processing when communicating with the management system 16. Client software on the management system 16 may be used in connection with performing data storage system management by issuing commands to the data storage system 12 and/or receiving responses from the data storage system 12 over connection 20. In one embodiment, the management system 16 may be a laptop or desktop computer system.

The particular data storage system 12 as described in this embodiment, or a particular device thereof, such as a disk, should not be construed as a limitation. Other types of commercially available data storage systems 12, as well as processors and hardware controlling access to these particular devices, may also be included in an embodiment.

In some arrangements, the data storage system 12 provides block-based storage by storing the data in blocks of logical storage units (LUNs) or volumes and addressing the blocks using logical block addresses (LBAs). In other arrangements, the data storage system 12 provides file-based storage by storing data as files of a file system and locating file data using inode structures. In yet other arrangements, the data storage system 12 stores LUNs and file systems, stores file systems within LUNs, and so on.

The two storage processors 114A, 114B (also referred to herein as “SP”) may control the operation of the data storage system 12. The processors may be configured to process requests as may be received from the hosts 14a-14n, other data storage systems 12, management system 16, and other components connected thereto. Each of the storage processors 114A, 114B may process received requests and operate independently and concurrently with respect to the other processor. With respect to data storage management requests, operations, and the like, as may be received from a client, such as the management system 16 of FIG. 1 in connection with the techniques herein, the client may interact with a designated one of the two storage processors 114A, 114B. Upon the occurrence of failure of one the storage processors 114A, 114B, the other remaining storage processors 114A, 114B may handle all processing typically performed by both storage processors 114A.

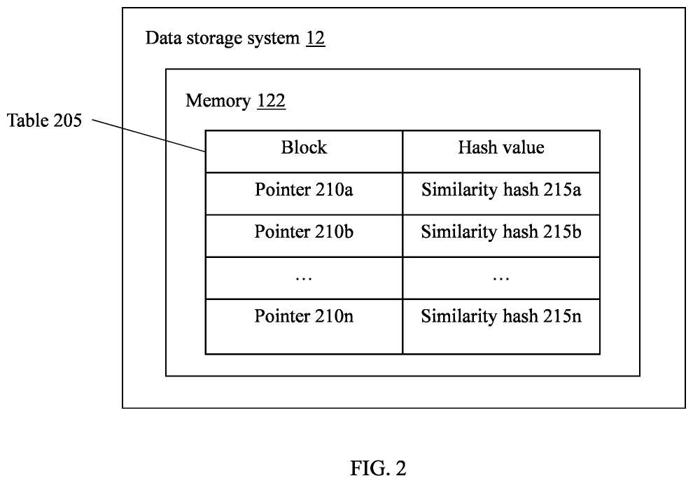

FIG. 2 depicts an exemplary embodiment of a data storage system 12 used in the computer system 10 of FIG. 1. In addition to the storage processors 114A, 114B and data storage devices 17a-17n depicted in FIG. 1, the data storage system 12 can include a memory 122. The memory 122 can include persistent memory (e.g., flash memory, magnetic memory) and non-persistent memory (e.g., dynamic random access memory (DRAM), static random access memory (SRAM)).

The memory 112 can store a table 205 of pointers 210a, 210b, . . . , 210n (collectively, “210”) to blocks in the data storage system 12 and their corresponding similarity hash values 215a, 215b, . . . , 215n (collectively, “215”). As the data storage system 12 receives data, the storage system 12 applies a similarity hash algorithm to determine the hash values 215 of the data blocks. In various embodiments, the similarity hash algorithm may be locality-sensitive hashing (LSH). The hash values 215 may be determined inline, or as part of a background process. The use of the hash values 215 to achieve dictionary-based compression will be described in more detail below.

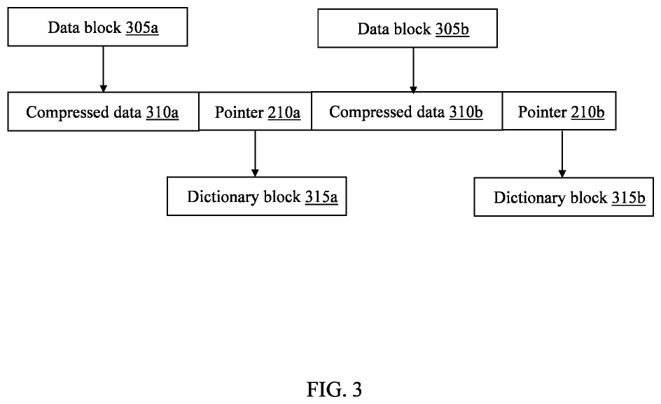

FIG. 3 depicts a schematic diagram of data blocks 305a, 305b (collectively referred to herein as “305”) as compressed and stored on a data storage device 17 of the data storage system 12, according to dictionary-based compression techniques described herein. After being compressed according to a dictionary based on a similar, previously stored block 315a, a data block 305a is stored as compressed data 310a. A pointer 210a to the similar block 315a (also referred to herein as a “dictionary block”) is stored in association with the compressed data 310a.

When the data storage system 12 receives a data block 305a, the storage system 12 determines whether a similar data block 315a has already been stored. The storage system 12 compares the similarity hash value 215 of the received data block 305a with the hash values 215 in the table 205. If the data storage system 12 determines that no similar data blocks have been previously stored, the received data block 305a itself is stored and its pointer 210 and similarity hash value 215 are added to the table 205. In some embodiments the received data block 305a may be compressed prior to storage. Exemplary compression algorithms include Deflate and Zstandard, although other algorithms may be used, as would be appreciated by one of ordinary skill in the art.

The table 205 may have a similarity hash value 215 that matches that of the received data block 305a. If so, the data storage system 12 can identify a stored data block 315a with the same byte sequence as the received data block 305a. However, the techniques described herein may be applied to data blocks 305, 315 that are similar, and the manner in which data blocks 305, 315 are identified as such may depend on attributes of the similarity hash algorithm being used. In some embodiments, the data storage system 12 identifies all hash values 215 in the table 205 within a threshold distance of the received data block's 305a hash value 215, and selects the stored data block 315a corresponding to the minimum threshold distance. In other embodiments, once the data storage system 12 finds a hash value 215 within the threshold distance of the received data block's 305a hash value 215, the data storage system 12 uses this stored data block 315a and does not search the remainder of the table 205.

The storage system 12 retrieves the stored data block 315a, and in some embodiments, decompresses the data. The storage system 12 uses the stored data block 315a to determine a dictionary for compressing the received block 305a. The manner in which the dictionary is determined may depend on the non-dictionary-based compression algorithm being used. For example, if the data storage system 12 is compressing data using Deflate, the data in the stored block 315a may be used as a dictionary. For example, the stored block 315a may be loaded into a compressor as an input for the Deflate compression algorithm. However, if Zstandard is being used, the stored data block 315a may be used as raw data to create a dictionary.

The data storage system 12 may compress the received data block 305a according to the dictionary, and also compress the same data 305a using other compression techniques (e.g., Deflate, Zstandard). The compression results are compared, and if the dictionary-based result 310a is superior to the other result by a certain threshold (e.g., 10%, 20%), the dictionary-based compression result 310a is stored, along with a pointer 210a to the stored data block 315a upon which the dictionary is based. If the dictionary-based technique does not yield an adequately superior outcome, the data block compressed according to other technique(s) is stored. In this manner, the data storage system 12 may store data based on the compression technique that achieves greater reduction in overall storage, which may also account for the overhead incurred by referring to data blocks upon which dictionaries are retrieved.

In some embodiments, the storage system 12 executes the steps of decompressing the stored data block 315a, creating a dictionary based on the stored data block 315a, and compressing the received data block 305a based on the dictionary, in hardware. The hardware may perform all three steps using a single command. In other embodiments, the hardware may use separate commands to perform each of these steps. In some embodiments, when the data storage system 12 uses Deflate, such as the version implemented in the open source library zlib available at https://github.com/madler/zlib, exemplary code for implementing an embodiment of the dictionary-based compression techniques described herein may include:
compressed_B=read(B)
raw_B=zlib.decompress(compressed_B)
zcompo=zlib.compressobj(zdict=raw_B)
zcomp.append(zcompo.compress(raw_A))
zcomp.append(zcompo.flush( ))

In further embodiments, when the data storage system 12 uses Zstandard, such as the version implemented in the open source library zstd available at https://github.com/facebook/zstd, exemplary code for implementing an embodiment of the dictionary-based compression techniques described herein may include:
compressed_B=read(B)
dctx=zstd.ZstdDecompressor( )
raw_B=dctx.decompress(compressed_B)
dict_data=zstd.ZstdCompressionDict(raw_B, dict_type=zstd.DICT_TYPE_RAWCONTENT)
zctx=zstd.ZstdCompressor(dict_data=dict_data)
compress=zctx.compress(raw_A)

A data block 310a compressed according to techniques described herein is stored with a pointer 210a to another block 315a, which forms the basis for the dictionary used to compress the data block (for clarity, the other block will be referred to as the “dictionary block”). If the dictionary block 315a has been stored in a compressed form, the storage system 12 decompresses the data. A dictionary is determined based on the dictionary block 315a, and as in the write process, the manner in which this dictionary is determined may depend on the non-dictionary-based compression algorithm being used. Thus, the dictionary block 315a may be used as input to a decompression engine (e.g., when Deflate is being used), or used as raw data for a dictionary (e.g., when Zstandard is being used). Then, the data block 305a being read is decompressed using this dictionary.

In some embodiments, the storage system 12 executes the steps of decompressing the dictionary block 315a, determining the dictionary based on the dictionary block 315a, and decompressing the data block 310a based on the dictionary, in hardware. The hardware may perform all three steps using a single command. In other embodiments, the hardware may use separate commands to perform each of these steps.

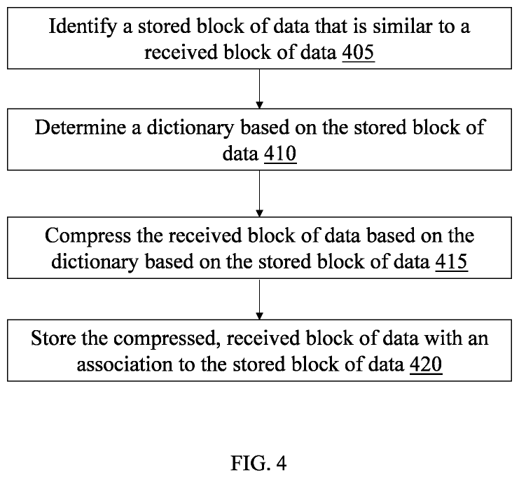

FIG. 4 is an exemplary flow diagram 400 of a method for dictionary-based compression in a block-based storage system. The storage system 12 identifies a stored block of data that is similar to a received block of data (step 405). The storage system 12 determines a dictionary based on the stored block of data (step 410). The storage system 12 may decompress the stored block of data. The received block of data is compressed based on this dictionary (step 415), and the compressed data is stored with an association to the stored block of data (step 420).

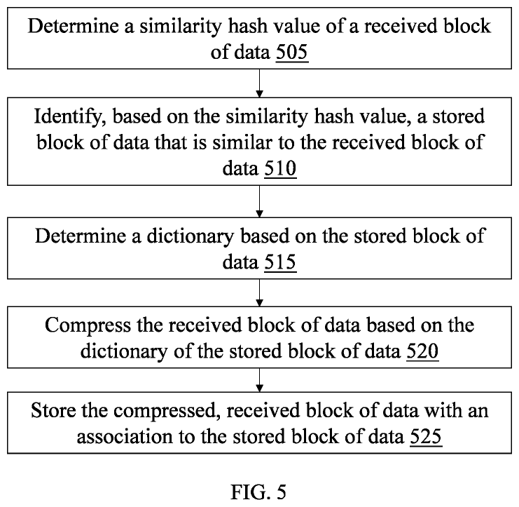

FIG. 5 is an exemplary flow diagram 500 of another method for dictionary-based compression in a block-based storage system. The storage system 12 determines a similarity hash value of a received block of data (step 505), and identifies, based on the similarity hash value, a similar stored block of data (step 510). The storage system 12 determines a dictionary based on the stored block of data (step 515), and may decompress the stored block of data. The storage system 12 compresses the received block of data based on this dictionary (step 520), and stores the compressed data with an association to the stored block of data (step 525).

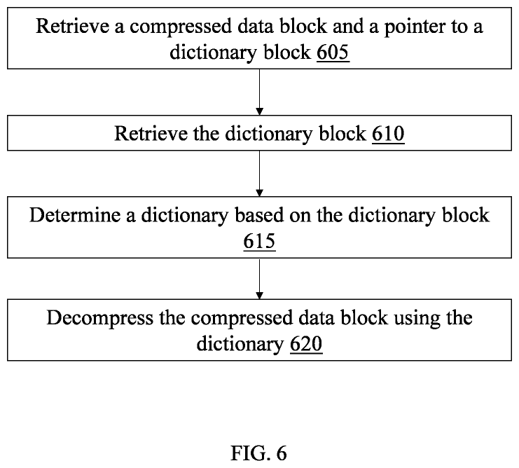

FIG. 6 is an exemplary flow diagram 600 of another method for dictionary-based compression in a block-based storage system. The storage system 12 retrieves a compressed data block and a pointer to a dictionary block (step 605), and retrieves the dictionary block (step 610). The storage system 12 may decompress the dictionary block. The storage system 12 determines a dictionary based on the dictionary block (step 615), and decompresses the compressed data block using the dictionary (step 620).

It should again be emphasized that the implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. A method for dictionary-based compression in a block-based storage system, the method comprising:
in response to receiving a block of data, identifying, by a processor of the block-based storage system, a stored block of data that is similar to the received block of data;
in response to the identifying, creating a dictionary based on the stored block of data;
compressing the received block of data based on the dictionary based on the stored block of data; and
storing the compressed, received block of data with an association to the stored block of data.

2. The method of claim 1, wherein identifying the stored block of data that is similar to the received block of data comprises:
determining a similarity hash value of the received block of data.

3. The method of claim 2, wherein identifying the stored block of data that is similar to the received block of data further comprises:
comparing the similarity hash value of the received block of data to similarity hash values of stored blocks of data.

4. The method of claim 3, wherein identifying the stored block of data that is similar to the received block of data further comprises:
selecting a stored block of data whose similarity hash value falls within a threshold of the similarity hash value of the received block of data.

5. (canceled)

6. The method of claim 1, wherein determining the dictionary based on the stored block of data comprises:
using the stored block of data as raw data for the dictionary.

7. A system for dictionary-based compression in a block-based storage system, the system including a processor configured to:
in response to receiving a block of data, identify a stored block of data that is similar to the received block of data;
in response to the identifying, creating a dictionary based on the stored block of data;
compress the received block of data based on the dictionary based on the stored block of data; and
store the compressed, received block of data with an association to the stored block of data.

8. The system of claim 7, wherein the processor is further configured to:
determine a similarity hash value of the received block of data.

9. The system of claim 8, wherein the processor is further configured to:
compare the similarity hash value of the received block of data to similarity hash values of stored blocks of data.

10. The system of claim 9, wherein the processor is further configured to:
select a stored block of data whose similarity hash value falls within a threshold of the similarity hash value of the received block of data.

11. (canceled)

12. The system of claim 7, wherein the processor is further configured to:
use the stored block of data as raw data for the dictionary.
